(19) United States
(12) Patent Application Publication
(10) Pub. No.: US 2026/0369098 A1
(43) Pub. Date: Nov. 19, 2026

(54) COMPUTERIZED PLATFORM FOR TRACKING ACTIVITY OF HUMAN OPERATORS IN DISTRIBUTED CONTROL SYSTEMS

(71) Applicant: ABB Schweiz AG, Baden (CH)

(72) Inventors: Stefano Mazza, Genova (IT); Federico Vivaldi, Genova (IT)

(21) Appl. No.: 19/566,284

(22) Filed: Mar. 13, 2026

(30) Foreign Application Priority Data
May 15, 2025 (EP) 25176564.0

(51) Int. Cl. G06V 40/16; G06V 10/70; G06V 20/52; H04N 7/18

(52) U.S. Cl. CPC G06V 40/172; G06V 10/70; G06V 20/52; H04N 7/181; H04N 7/188

(57) ABSTRACT

A computerized platform for a distributed control system comprising one or more computerized stations accessible by human operators and a computerized structure interacting with said computerized stations. The computerized platform comprises one or more cameras, each arranged at a corresponding computerized station and configured to shoot a human operator at said computerized station. The computerized platform comprises a first computerized module operatively associated with said cameras. The first computerized module is configured to acquire, from each camera, an image of a human operator who sent a command to said computerized structure through the computerized station, at which said camera is arranged. The computerized platform further comprises a second computerized module operatively associated with said first computerized module and with said computerized structure. The second computerized module is configured to detect commands transmitted by the computerized station to the computerized structure.

### CROSS REFERENCE TO RELATED APPLICATIONS

The present application claims priority to European Patent Application No. 25176564.0 filed on May 15, 2025, and titled “A COMPUTERIZED PLATFORM FOR TRACKING THE ACTIVITY OF HUMAN OPERATORS IN DISTRIBUTED CONTROL SYSTEMS”, which is hereby incorporated by reference in its entirety.

### TECHNICAL FIELD

The present disclosure concerns the field of distributed control systems (DCS) for industrial applications. More specifically, the present disclosure relates to a computerized platform that allows tracking the activity of human operators at control stations of a DCS.

### BACKGROUND

In industrial environments, ensuring the safety and accountability of the actions of human operators accessing the control stations is extremely important to ensure proper management of a distributed control system.

Currently, distributed control systems employ authentication mechanisms to allow human operators to access the control stations. However, it is quite common for a human operator to log-on to a control station at the beginning of a shift and remain logged-on even if he/she does not operate at said control station. In this case, all operating commands sent from that control station, after the first access, are recorded with the credentials of the logged-on person, even if other individuals send them.

As it is easy to understand, this circumstance can lead to gaps and problems in ascertaining responsibility in the management of a distributed control system, in some embodiments, in high-pressure situations where many people can actively use the control station. In the event of an accident or troubleshooting, it may be quite difficult to trace the individual responsible for sending a certain critical command.

### BRIEF DESCRIPTION

The main purpose of the present disclosure is to provide a computerized platform for distributed control systems that allows overcoming or mitigating the above-described drawbacks of the state of the art. The embodiments and features, if any, described in this specification that do not fall under the scope of the independent claim are to be interpreted as examples useful for understanding various embodiments of the present disclosure.

Within this task, an object of the present disclosure is to provide a computerized platform allowing a human operator, who sent a certain command through a given control station, to be uniquely identified and tracked.

A further object of the present disclosure is to provide a computerized platform, which can be easily interfaced with the computerized resources of a distributed control system.

A further object of the present disclosure is to provide a computerized platform, which is relatively simple to implement in practice, at market-competitive costs.

This task and these objects, in addition to other objects that will be evident from the following description and the attached drawings, are achieved, according to the present disclosure, by a computerized platform, according to independent claims and the relative dependent claims proposed below.

In a general definition, the computerized platform, according to the present disclosure, is adapted to track the activity of human operators in a DCS, which comprises one or more computerized stations accessible by human operators and a central computerized structure interacting with said computerized stations.

The computerized platform, according to the present disclosure, comprises one or more cameras, each of which is arranged at a corresponding computerized station of the DCS. Each camera is configured to capture an image of a human operator present at the corresponding computerized station.

The computerized platform, according to the present disclosure, comprises a first computerized module operatively associated with said cameras.

The first computerized module is configured to acquire, from each camera, an image of a human operator, who sent a command to said central computerized structure through the computerized station, at which said camera is arranged.

The first computerized module is configured to provide an identification profile of the shot human operator based on said acquired image.

In some embodiments, the first computerized module is configured to compare the acquired image with a collection of stored images of human operators. To this aim, the first computerized module, in some embodiments, employs a machine learning tool or an artificial intelligence tool.

In some embodiments, the first computerized module is configured to retrieve a stored identification profile of a human operator, which corresponds to the acquire image, and provide the retrieved identification profile to a second computerized module of said computerized platform, if the acquired image matches with a stored image of said human operator.

In some embodiments, the first computerized module is configured to generate a temporary anonymous identification profile of a human operator, store the acquired image and said temporary anonymous identification profile in association and provide said temporary anonymous identification profile to a second computerized module of said computerized platform, if the acquired image does not match with any stored image of human operators.

The computerized platform, according to the present disclosure, comprises a second computerized module operatively associated with said first computerized module and with said central computerized structure.

The second computerized module is configured to detect commands transmitted by said computerized stations to said central computerized structure.

For each detected command, the second computerized module is configured to acquire an identification profile from said first computerized module, which relates to a human operator who sent the detected command through a computerized station, generate log information associating the detected command with an identification profile acquired from said first computerized module and store said log information.

In some embodiments, the second computerized module is configured to activate said first computerized module and the camera arranged at the computerized station that transmitted the detected command, for each detected command.

In some embodiments, the computerized platform, according to the present disclosure, comprises one or more computerized user-interface devices operatively associated to said first computerized module. Each user-interface computerized device is configured to allow a user to interact with said computerized platform.

In some embodiments, each user-interface device is configured to store new images and new identification profiles of human operators in order to update corresponding collections of stored images and stored identification profiles.

In some embodiments, each user-interface device is configured to modify stored images and stored identification profiles of human operators in order to update corresponding collections of stored images and stored identification profiles.

In further aspect, the present disclosure relates to a computer-implemented method for tracking the activity of a human operator in a distributed control system, according to claim 1 and the relative dependent claims proposed below.

The method, according to the present disclosure, comprises the following activities:
detecting a command transmitted by a computerized station of the DCS to a central computerized structure of the DCS;
acquiring, from a camera arranged at said computerized station, an image of a human operator who sent the detected command through said computerized station;
providing an identification profile of said human operator based on the acquired image;
generating and storing log information associating the detected command and said identification profile.

In some embodiments, the method, according to the present disclosure, comprises the activity of activating the camera arranged at the computerized station that transmitted a detected command, upon detecting said command.

In some embodiments, the activity of providing an identification profile comprises:
comparing the acquired image with a collection of stored images of human operators;
if the acquired image matches with a stored image of a human operator, retrieving a stored identification profile of said human operator and providing the retrieved identification profile to said second computerized module;
if the acquired image does not match with any stored image of human operators, generating a temporary anonymous identification profile of a human operator, storing the acquired image and said temporary anonymous identification profile and providing said temporary anonymous identification profile to said second computerized module.

In some embodiments, the acquired image is compared with said collection of stored images of human operators through a machine learning tool or an artificial intelligence tool.

### BRIEF DESCRIPTION OF DRAWINGS

The subject matter of the present disclosure will be explained in more detail in the following text with reference to exemplary embodiments which are illustrated in the attached drawings.

FIG. 1 schematically illustrates the computerized platform, according to the present disclosure.

FIG. 2 schematically illustrates a method for tracking the activity of human operators in a distributed control system, which can be implemented by the computerized platform, according to the present disclosure.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

With reference to the cited figures, the present disclosure refers to a computerized platform 1 for tracking the activity of human operators in a distributed control system (DCS).

The DCS comprises one or more computerized stations 101 that are accessible by human operators and a computerized structure 102 interacting with said computerized stations.

For the sake of clarity, it is specified that, in the context of the present disclosure, the term “human operator” indicates any physical person intending to use a computerized station 101 to interact with the computerized structure 102, for example to receive information or send data and/or commands.

The computerized stations 101 are, in some embodiments, client stations of the DCS while the computerized structure 102 is, in some embodiments, the control system server of the DCS.

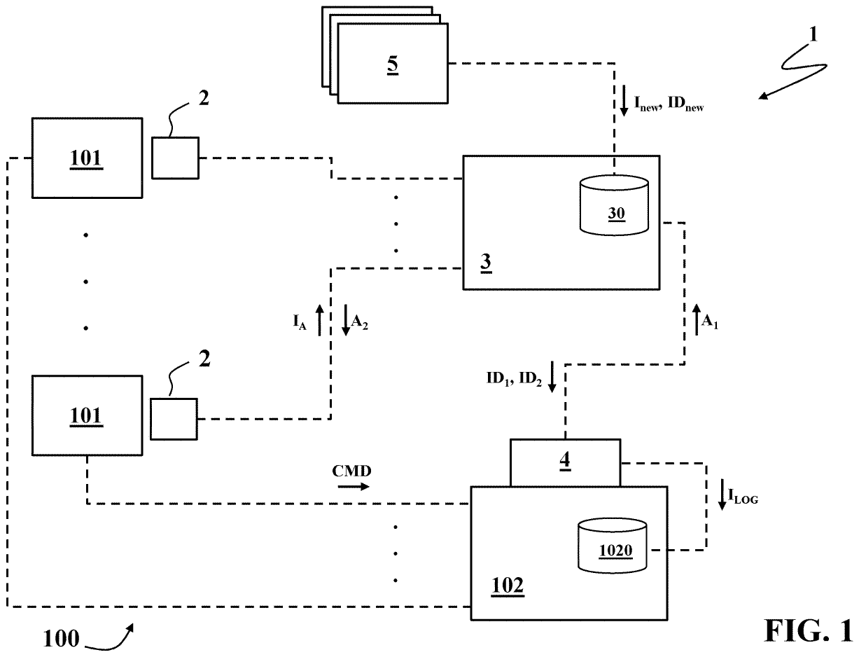

In some embodiments, the computerized structure 102 includes (as shown in FIG. 1) or is operatively associated with a first memory 1020, which may be, for example, a database of the DCS or a database of another computerized system made available to the DCS.

Each computerized station 101 can be accessed by a human operator through a log-on procedure implementing a suitable authentication mechanism, which may be of known type, for example of the biometric type.

Each computerized station 101 may physically consist of one or more computerized devices including suitable user-interface means, for example keyboards and screens, to allow a human operator to receive any information of interest and send data and/or commands.

The computerized structure 102 may comprise a plurality of computerized modules.

For the sake of clarity, it is specified that, in the context of the present disclosure, the term “computerized module” refers to a set of hardware and software resources (for example including one or more computerized devices executing suitable software programs and interacting with one another) designed to perform some functions of interest.

The computerized stations 101 and the computerized structure 102 can be remotely located one from another. For example, the computerized stations 101 can be located at level of the control room of an industrial plant while the computerized structure 102 can be arranged in protected site or also be implemented at cloud level.

The computerized stations 101 and the computerized structure 102 can communicate according to known communication methods, for example via the Internet or any dedicated digital communication network, for example a LAN. Commonly available communication protocols, for example a TCP/IP communication protocol, can be used for this purpose.

In general, the computerized stations 101 and the computerized structure 102 can be realized according to solutions of known type. Therefore, in the following, they will not be described in further detail, for the sake of brevity.

According to the present disclosure, the computerized platform 1 comprises one or more cameras 2, each of which is arranged at a corresponding computerized station 101.

The cameras 2 can capture images I_{A} of human operators working at the corresponding computerized stations 101. Namely, in operation, each camera 2 can capture an image of a human operator as soon as this latter sends a commands CMD to the computerized structure 102 through the computerized station 101, at which said camera is arranged.

In some embodiments, each camera 2 is normally in a stand-by state and starts shooting the human operator physically present at the corresponding computerized station 101 upon receiving a suitable activation command A₂ from a certain computerized module 3 of the computerized platform.

In general, the cameras 2 of the computerized platform can be realized according to solutions of known type. For example, they can be commercially available digital cameras. Therefore, in the following, they will not be described in further detail, for the sake of brevity.

According to the present disclosure, the computerized platform 1 comprises a first computerized module 3 operatively associated with the cameras 2.

The first computerized module 3 and the cameras 2 can communicate according to known communication methods, for example via the Internet or any dedicated digital communication network, for example a LAN.

In some embodiments, the first computerized module 3 includes (as shown in FIG. 1) or is operatively associated with a second memory 30, for example a database of the computerized platform or a database of another computerized system made available to the computerized platform.

In some embodiments, the first computerized module 3 is physically distinct from the computerized structure 102. In principle, however, the first computerized module 3 can even be physically integrated with the computerized structure 102.

According to the present disclosure, in operation, the first computerized module 3 acquires images I_{A} of human operators provided by the cameras 2 and provides identification profiles ID₁ or ID₂ of the shot human operators.

Namely, the first computerized module 3 acquires from each camera 2 an image I_{A} of a human operator who sent a command CMD to the central computerized structure 102 through the corresponding computerized station 101, at which the camera is arranged, and it provides an identification profile ID₁ or ID₂ of said human operator based on the corresponding acquired image I_{A}.

In some embodiments, also the first computerized module 3 is normally in a stand-by state and starts operating upon receiving a suitable activation command A₁ from a further computerized module of the computerized platform.

In some embodiments, the first computerized module 3 carries out a facial recognition process, which exploits predefined information stored in the second memory 30 of the computerized platform, in order to provide an identification profile ID₁ or ID₂ of the shot human operator.

In the second memory 30 of the computerized platform, in fact, there are, in some embodiments, stored a collection of images of human operators and a collection of identification profiles of human operators. The stored images relate to human operators, who can potentially access to the above-mentioned computerized stations 101, while each stored identification profile is associated to a corresponding stored image and includes information (for example, name, birth date, authorization level, and the like) univocally identifying the human operator of the associated stored images.

As it will be better explained in the following, the stored collections of images and identification profiles can be updated routinely through a suitable web client computer.

In some embodiments, the first computerized module 3 compares an image I_{A} acquired from a camera 2 with the collection of images of human operators, which is stored in the second memory 30, and checks whether the acquired image I_{A} matches with an image already stored in the second memory 30.

To the above purpose, the first computerized module 3, in some embodiments, employs a machine learning or artificial intelligence tool, which can be implemented in practice according to solutions of known type. The use of these tools, which can be commercially available, allows increasing remarkably the speed and the efficiency of the facial recognition process.

If the acquired image I_{A} is determined to match with a stored image of a human operator, the first computerized module 3 retrieves a stored identification profile ID₁ of the shot human operator, which corresponds to the acquired image (and found stored image), and provides the retrieved identification profile ID₁ to a further computerized module 4 of the computerized platform.

If the acquired image I_{A} is determined not to match with any stored image of human operators, the first computerized module 3 generates a temporary anonymous identification profile ID₂ of a human operator, associates and stores the acquired image and the temporary anonymous identification profile ID₂ in the second memory 30, and provides the generated temporary anonymous identification profile ID₂ to a further computerized module 4 of the computerized platform.

It is evidenced how the first computerized module 3 always provides an identification profile ID₁ or ID₂ in response to acquiring the image I_{A} of a human operator from a camera 2, even when a known identification profile can be associated to said human operator.

This is quite important to track exhaustively the activity of human operators at the computerized stations 101. Even determining that an unknown human operator sent a certain command to the computerized structure 102 through a given computerized station 101 can provide useful information to ascertain any responsibility in the management of the DCS, whenever necessary.

According to the present disclosure, the computerized platform 1 comprises a second computerized module 4 operatively associated with first computerized module 3 and the computerized structure 102.

In some embodiments, the second computerized module 4 is physically integrated with the computerized structure 102. In principle, however, the second computerized module 4 can be physically distinct from the computerized structure 102. Similarly, the second computerized module 4 can be physically integrated with or distinct from the first computerized module 3.

The second computerized module 4 can communicate with the first computerized module 3 and the computerized structure 102 according to known communication methods, for example via the Internet or any dedicated digital communication network, for example a LAN.

In some embodiments, the second computerized module 4 can interact with the first memory 1020 of the DCS, for example with the purpose of storing information therein.

According to the present disclosure, the second computerized module 4 can detect commands CMD transmitted by any of the computerized stations 101 to the central computerized structure 102.

The second computerized 4 can advantageously employ a suitable software detection tool (which may be of known type) to analyze the data packets incoming from the computerized stations 101 and directed to the computerized structure 102. In this way, the second computerized module 4 can determine whether a data packet is a command sent by a computerized station 101 and identify which computerized station 101 transmitted said command.

In some embodiments, upon detecting a certain command CMD, the second computerized module 4 activates the first computerized module 3 and the camera 2 arranged at the computerized station 101, which transmitted the detected command. As mentioned above, in fact, these components of the computerized platform are normally in a stand-by state.

According to the present disclosure, for each detected command CMD, the second computerized module 4 acquires from the first computerized module 3 an identification profile ID₁ or ID₂. The acquired identification profile relates to the human operator who was physically present at the computerized station 101, when this latter transmitted the detected command CMD.

According to the present disclosure, for each detected command CMD, the second computerized module 4 generates log information I_{LOG} that associates the detected commands CMD with the identification profiles ID₁ or ID₂ received from the first computerized module 3 and store the log information I_{LOG} so generated.

Namely, for each detected command CMD, the second computerized module generates log information I_{LOG}, which associates the detected command CMD to an identification profile ID₁ or ID₂ acquired from the first computerized module 3, and it stores the log information I_{LOG} in the first memory 1020 of the DCS.

The stored log information I_{LOG} allows univocally identifying the human operator (who may be temporarily anonymous) who sent the detected command CMD through a corresponding computerized station 101. Such stored information can be conveniently checked whenever it is necessary to analyze the management activity of the DCS.

The operation of the computerized platform 1 is briefly summarized in the following.

It is supposed that a certain instant in time, a human operator sends a command CMD to the computerized structure 102 through a certain computerized station 101.

The second computerized module 4 detects the command CMD directed to the computerized structure 102 and transmits a first activation signal A₁ to activate the first computerized module 3. In response to receiving such an activation signal, the first computerized module 3 transmits a second activation signal A₂ to the camera 2 of interest.

In response to the activation by the second computerized module 4, the camera 2 provides an image I_{A} of the human operator, who is physically present at the computerized station 102, to the first computerized module 3.

On the other hand, in response to receiving the image I_{A} from the camera 2, the first computerized module 3 provides an identification profile ID₁ or ID₂ of the shot human operator. To this purpose, the first computerized module 3 can operate as explained above.

In response to receiving the above-mentioned identification profile, the second computerized module 4 generates log information I_{LOG}, which associates the detected command CMD to the acquired identification profile ID₁ or ID₂. The second computerized module 4 stored the generated log information I_{LOG} in the first memory 1020 of the DCS.

The computerized platform 1 advantageously repeats the above-mentioned operations for any detected command CMD incoming from any computerized station 101.

It is evidenced how the operation of the computerized platform 1 is silent with respect to the normal functionalities of the DCS. As an example, the computerized platform 1 does not interfere in any way with the log-on procedures or alarm procedures of the DCS.

In some embodiments, the computerized platform 5 comprises one or more user-interface computerized devices 5 operatively associated to the first computerized module 3 and allowing a user (for example an administrator) to interact with the computerized platform.

Each computerized device 5 is, in some embodiments, a web-client of the computerized platform.

The computerized devices 5 and the first computerized module 3 can communicate according to known communication methods, for example via the Internet or any dedicated digital communication network, for example a LAN.

Advantageously, each computerized device 5 can interact with the second memory 30 of the computerized platform, for example with the purpose of storing information therein.

In some embodiments, each user-interface device 5 can store new images I_{new} and new identification profiles ID_{new} of human operators in the second memory 30. In this way, a user can update the collections of stored images and stored identification profiles with images and identification profiles of new human operators that are supposed to access to the computerized stations 101.

In some embodiments, each user-interface device 5 can modify stored images and stored identification profiles of human operators. In this way, a user can correct errors or inconsistencies or update the stored temporary anonymous identification profiles ID₂ once the related human operators have been fully identified.

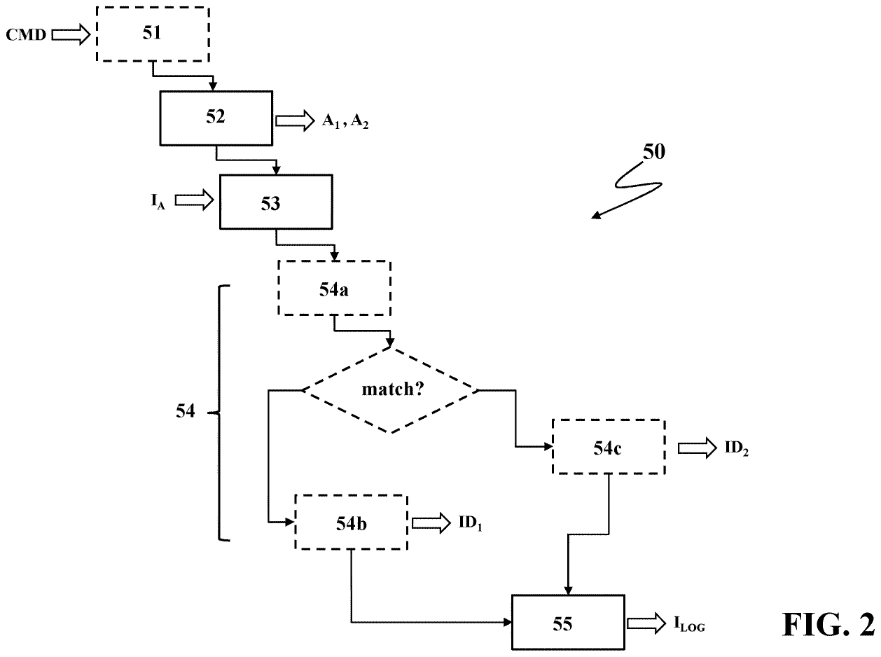

Referring now also to FIG. 2, in a further aspect, the present disclosure relates to a computer-implemented method 50 for tracking the activity of human operators in a DCS.

As explained above, the DCS comprises one or more computerized stations 101 accessible by human operators and a computerized structure 102 interacting with said computerized stations.

The method 50 comprises an activity 51 of detecting a command CMD transmitted by a certain computerized station 101 to the central computerized structure 102.

The detection of a command CMD allows identifying the computerized station 101 that transmitted the detected command.

Upon detecting the command CMD, the method 50, in some embodiments, comprises an activity 52 of activating a camera 2, which is arranged at the computerized station 101 that transmitted the detected command.

The method 50 then comprises an activity 53 of acquiring from the camera 2, which is arranged at the computerized station 101 that transmitted the detected command, an image I_{A} of a human operator who is physically present at said computerized station and therefore sent the detected command through said computerized station.

The method 50 then comprises an activity 54 of providing an identification profile ID₁ or ID₂ of the human operator shot by the camera 2 based on the acquired image I_{A}.

In some embodiments, the activity 54 of providing an identification profile comprises a sub-activity 54a of comparing the acquired image I_{A} with a collection of stored images of human operators.

In some embodiments, the comparison activity 54a is carried out through a machine learning tool or an artificial intelligence tool.

If the acquired image I_{A} matches with a stored image of a human operator, the activity 54 of providing an identification profile comprises a sub-activity 54b of retrieving a stored identification profile ID₁ of said human operator (in practice the identification profiles that corresponds to the acquired image I_{A}) and providing the retrieved identification profile ID₁ for further processing.

If the acquired image I_{A} does not match with any stored image of human operators, the activity 54 of providing an identification profile comprises a sub-activity 54c of generating an anonymous identification profile ID₂ of a human operator, storing the acquired image I_{A} and the anonymous identification profile ID₂ in the second memory 30 and providing said anonymous identification profile for further processing.

The method 50 then comprises an activity 55 of generating log information I_{LOG} associating the detected command CMD and the identification profile ID₁ or ID₂. The activity 55 includes also storing the generated information I_{LOG} in the first memory 1020 of the DCS.

The method 50, according to the present disclosure, as illustrated above, can be repeated for any detected command CMD incoming from any computerized station 101.

The above-mentioned method 50 can be advantageously implemented by a computerized platform, for example the computerized platform 1, as described above.

The computerized platform, according to present disclosure, offers numerous advantages with respect to the solutions of the known art.

The computerized platform, according to the present disclosure, allows tracking uniquely the activity of human operators sending commands to the control stations of the DCS. In this way, it is possible to collect and store log information, which allows reconstructing the activity of the human operators working in a control room of the DCS, whenever necessary.

The computerized platform, according to the present disclosure, collects the above-mentioned log information in a transparent way in relation to the operation of the DCS, in particular with the log-on procedures and the alarms procedure of this latter.

In practice, the computerized platform operates as a sort of “black-box”, which registers the commands transmitted by the computerized stations of the DCS and stores log information associating each detected command to an identification profile of a human operator, who actually sent the detected command by physically accessing to the computerized station (even if this person is not the logged-on user).

The computerized platform, according to the present disclosure, can be easily interfaced and integrated with the computerized resources of a DCS. As it operates in support to the functionalities of the DCS without interfering with these latter, the computerized platform is particularly adapted to retrofiring interventions on existing DCS.

The computerized platform 1 can be implemented at practical level with hardware/software resources commonly used in the information technology field. It is therefore relatively simple to implement industrially, at market-competitive costs.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practising the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A computerized platform for a distributed control system, wherein the distributed control system comprises one or more computerized stations accessible by human operators and a computerized structure interacting with the computerized stations, wherein the computerized platform comprises:
one or more cameras, each arranged at a corresponding computerized station and configured to capture an image of a human operator at the computerized station;
a first computerized module operatively associated with the cameras, wherein the first computerized module is configured to acquire, from each camera, an image of a human operator who sent a command to the computerized structure through the computerized station at which the camera is arranged, and wherein, the first computerized module is configured to provide an identification profile of the human operator based on the acquired image; and
a second computerized module operatively associated with the first computerized module and with the computerized structure, wherein the second computerized module is configured to detect commands transmitted by the computerized stations to the computerized structure, and wherein, for each detected command, the second computerized module is configured to acquire an identification profile of a human operator who sent the detected command from the first computerized module, generate log information associating the detected command with the acquired identification profile, and store the log information.

2. The computerized platform, according to claim 1, wherein, for each detected command, the second computerized module is configured to activate the first computerized module and the camera arranged at the computerized station that transmitted the detected command.

3. The computerized platform, according to claim 1, wherein the first computerized module is further configured to:
compare the acquired image with a collection of stored images of human operators;
if the acquired image matches with a stored image of a human operator, retrieve a stored identification profile of the human operator, which corresponds to the acquired image, and provide the retrieved identification profile to the second computerized module; and
if the acquired image does not match with any stored image of human operators, generate a temporary anonymous identification profile of a human operator, store the acquired image and the temporary anonymous identification profile in association and provide the temporary anonymous identification profile to the second computerized module.

4. The computerized platform according to claim 3, wherein the first computerized module employs a machine learning tool or an artificial intelligence tool to compare an acquired image with a collection of stored images of human operators.

5. The computerized platform, according to claim 1, wherein the computerized platform further comprise one or more computerized user-interface devices operatively associated to the first computerized module, each user-interface computerized device configured to allow an administrator user to interact with the computerized platform.

6. The computerized platform, according to claim 5, wherein each user-interface device is configured to store new images and new identification profiles of human operators to update corresponding collections of stored images and stored identification profiles.

7. The computerized platform, according to claim 6, wherein each user-interface device is configured to modify stored images and stored identification profiles of human operators to update corresponding collections of stored images and stored identification profiles.

8. A distributed control system including a computerized platform, wherein:
the distributed control system comprises one or more computerized stations accessible by human operators and a computerized structure interacting with the computerized stations, and
the computerized platform comprises:
one or more cameras, each arranged at a corresponding computerized station and configured to capture an image of a human operator at the computerized station;
a first computerized module operatively associated with the cameras, wherein the first computerized module is configured to acquire, from each camera, an image of a human operator who sent a command to the computerized structure through the computerized station at which the camera is arranged, and wherein, the first computerized module is configured to provide an identification profile of the human operator based on the acquired image; and
a second computerized module operatively associated with the first computerized module and with the computerized structure, wherein the second computerized module is configured to detect commands transmitted by the computerized stations to the computerized structure, and wherein, for each detected command, the second computerized module is configured to acquire an identification profile of a human operator who sent the detected command from the first computerized module, generate log information associating the detected command with the acquired identification profile, and store the log information.

9. A computer-implemented method for tracking an activity of human operators in a distributed control system, wherein the distributed control system comprises one or more computerized stations accessible by human operators and a computerized structure interacting with the computerized stations, wherein the computer-implemented method comprises:
detecting a command transmitted by a computerized station to the computerized structure;
acquiring, from a camera arranged at the computerized station, an image of a human operator who sent the detected command through the computerized station;
providing an identification profile of the human operator based on the acquired image; and
generating and storing log information associating the detected command and the identification profile.

10. The computer-implemented method according to claim 9, further comprising:
activating the camera upon detecting the command.

11. The computer-implemented method according to claim 9, wherein providing an identification profile further comprises:
comparing the acquired image with a collection of stored images of human operators;
if the acquired image matches with a stored image of a human operator, retrieving a stored identification profile of the human operator, which corresponds to the acquired image, and providing the retrieved identification profile to a second computerized module; and
if the acquired image does not match with any stored image of human operators, generating a temporary anonymous identification profile of a human operator, storing the acquired image and the temporary anonymous identification profile, and providing the temporary anonymous identification profile to the second computerized module.

12. The computer-implemented method according to claim 11, wherein the acquired image is compared with the collection of stored images of human operators through a machine learning tool or an artificial intelligence tool.

13. The computerized platform, according to claim 2, wherein the first computerized module is further configured to:
compare the acquired image with a collection of stored images of human operators;
if the acquired image matches with a stored image of a human operator, retrieve a stored identification profile of the human operator, which corresponds to the acquired image, and provide the retrieved identification profile to the second computerized module; and
if the acquired image does not match with any stored image of human operators, generate a temporary anonymous identification profile of a human operator, store the acquired image and the temporary anonymous identification profile in association and provide the temporary anonymous identification profile to the second computerized module.

14. The computerized platform according to claim 13, wherein the first computerized module employs a machine learning tool or an artificial intelligence tool to compare an acquired image with a collection of stored images of human operators.

15. The computerized platform, according to claim 14, wherein the computerized platform further comprise one or more computerized user-interface devices operatively associated to the first computerized module, each user-interface computerized device configured to allow an administrator user to interact with the computerized platform.

16. The computerized platform, according to claim 15, wherein each user-interface device is configured to store new images and new identification profiles of human operators to update corresponding collections of stored images and stored identification profiles.

17. The computerized platform, according to claim 16, wherein each user-interface device is configured to modify stored images and stored identification profiles of human operators to update corresponding collections of stored images and stored identification profiles.

18. The distributed control system according to claim 8, wherein, for each detected command, the second computerized module is configured to activate the first computerized module and the camera arranged at the computerized station that transmitted the detected command.

19. The distributed control system according to claim 8, wherein the first computerized module is further configured to:
compare the acquired image with a collection of stored images of human operators;
if the acquired image matches with a stored image of a human operator, retrieve a stored identification profile of the human operator, which corresponds to the acquired image, and provide the retrieved identification profile to the second computerized module; and
if the acquired image does not match with any stored image of human operators, generate a temporary anonymous identification profile of a human operator, store the acquired image and the temporary anonymous identification profile in association and provide the temporary anonymous identification profile to the second computerized module.

20. The distributed control system according to claim 19, wherein the first computerized module employs a machine learning tool or an artificial intelligence tool to compare an acquired image with a collection of stored images of human operators.
